(19) United States
(12) Patent Application Publication
(10) Pub. No.: US 2018/0142668 A1
(43) Pub. Date: May 24, 2018

(54) HYDROELECTRIC APPARATUS

(71) Applicant: BLUE FREEDOM GMBH, Diessen am Ammersee (DE)

(72) Inventors: Stefan PACARDO, Stein (DE); Leif SCHOELLER, Fuerth (DE); Benedict PADBERG, Gilching (DE); Benedikt SCHROEDER, Riederau (DE)

(21) Appl. No.: 15/545,426

(22) PCT Filed: Dec. 23, 2015
(86) PCT No.: PCT/EP2015/081225

§ 371 Date: Jul. 21, 2017

(30) Foreign Application Priority Data
Jan. 24, 2015 (GB) 1501185.1

(51) Int. Cl. F03B 17/06

(52) U.S. Cl. CPC F03B 17/061; F05B 2240/62

(57) ABSTRACT

The disclosure relates to an apparatus for generating electric power from a fluid current. The apparatus comprises a generator unit, a flexible shaft that is, at a first end, rotatably attached to the generator unit, and at a second end attached to a turbine. The turbine comprises a plurality of blades and a rim attached to the plurality of blades.

### FIELD OF THE INVENTION

The present disclosure relates to an apparatus for generating electric power from flowing water currents. In particular the present disclosure relates to mobile hydroelectric apparatus or water power stations.

### INTRODUCTION

The power of falling or flowing water currents has been used for long for generating electricity in different scales. Most water power plants are fixedly installed in water dams and use the gravitational and or kinetic energy of water for generating electricity by converting the flowing water current into a rotational movement that is used drive an electric generator. This requires large and stationary constructions.

There are presently no systems available that allow for more flexible production of electric energy from a flowing liquid current.

There is a need for improved devices for generating electricity from a flowing liquid current such as a water current that can be easily and reversibly installed.

### SUMMARY OF THE INVENTION

The disclosure relates to an apparatus for generating electric power from a fluid current and a turbine for such an apparatus according to the independent claims.

The apparatus comprises a generator unit, a flexible shaft that is, at a first end, rotatably attached to the generator unit, and at a second end attached to a turbine. The turbine comprises a plurality of blades and a rim or frame attached to at least two of the plurality of blades.

The turbine comprises a central shaft, a plurality of blades and a rim attached to at least two of the plurality of blades. The rim may have a thickness that varies along a flow direction.

Further examples and aspect of the present disclosure are defined in the dependent claims.

### DESCRIPTION OF THE FIGURES

The invention may be better understood when reading the detailed description of examples of the present disclosure which are given with respect to the accompanying figures in which:

FIGS. 1 a and b show an example of an hydroelectric apparatus;

FIG. 2 shows the hydroelectric apparatus of FIG. 1 in use;

FIGS. 3a and b show a further example of an hydroelectric apparatus;

FIGS. 4, 5a and 5b show the turbine of FIGS. 1 and 2 in more detail in different views; and

FIG. 6 shows a cross section through the turbine of the previous figures;

FIGS. 7a and b show perspective view of a second example of a turbine in different views;

FIG. 8 shows a top view of the second example shown in FIGS. 7a and 7b.

FIGS. 9 and 10 show different cross-sections of the second example shown in FIGS. 7a and 7b and 8.

FIG. 11 shows the turbine of the previous figures inserted in the housing of the hydroelectric apparatus.

### DETAILED DESCRIPTION

Examples of the present disclosure will now be described in more detail. It is to be understood that the described examples and the examples shown in the figures are purely illustrative and a person skilled in the art will amend the examples according to specific requirements. It is not necessary to implement all features shown in the examples and features shown with respect to one figure can be freely combined with features shown or described with respect to other examples or shown in other figures, unless specifically excluded.

The present disclosure relates to hydroelectric apparatus for generating electricity from a flowing fluid current, in particular from a water current.

The hydroelectric apparatus comprises a turbine, a flexible shaft and a generator. The turbine is adapted to rotate when a fluid such as water is flowing through the turbine. The turbine is connected via a flexible shaft or cable to a generator.

The generator may be arranged in a housing which can comprise additional elements such as electronics, connections and others as explained below.

The hydroelectric apparatus may be portable and can be used as a mobile power plant. For example, the hydroelectric apparatus can be easily carried to remote places to generate electricity for charging batteries, mobile communication devices, torches and other electric equipment wherever a flowing water current is present. A water driven generator such as the hydroelectric apparatus has the advantage that electricity can be generated independently of weather conditions and independently of the day time while solar power panels only work during day light and only in sunny weather.

The turbine can be placed in any water current. No specific construction, modification of the flow, or specific flow characteristics is required. The turbine can be placed in any water current as long as there is enough room for rotation of the turbine.

The turbine comprises a plurality of blades and a rim attached to at least two of the plurality of blades. The rim can be attached to the outermost ends of the plurality of blades. The rim can be attached to each one of the plurality of blades. The rim or frame has the shape similar to a cylindrical wall and provides a channel for the fluid current that increases efficiency of the turbine, and centers and orientates the turbine in the fluid current.

The rim may have a substantially cylindrical shape and/or may have the shape of a truncated cone. The channel formed inside the truncated cone may have a varying cross section and may increase or decrease along a flow direction of the fluid. For example, the cross section (Dh) at the channel entrance at a high pressure side may be smaller than a cross section (Dl) at the channel exit at a low pressure side. This again, increases efficiency of the turbine.

In addition or as an alternative to the shape of the truncated cone, the inner cross section of the channel may have a minimum in a channel section between the channel entrance and the channel exit. This can be achieved by varying the thickness of the rim and/or by varying the diameter or the shape of the central shaft along the channel.

The cannel formed by the rim may comprise a guiding portion and a blades portion, wherein the guiding portion is arranged in front of the blades portion with respect to a flow direction and wherein the plurality of blades is arranged in the blades portion. The guiding portion aligns and centers the turbine in the fluid current.

The following description describes aspects and examples of the apparatus of the present disclosure with respect to the accompanying Figures. The example shows a mobile hydroelectric power plant that is used in water current such as a river, a creek or the like. However, the apparatus of the present disclosure can be equally used with any type of water current, such as fresh water, raw, waste water, black or greywater or sullage. Moreover the apparatus of the present disclosure can be used or adapted for use with any other liquid or fluid. Gases may be used or even grains of a solid material.

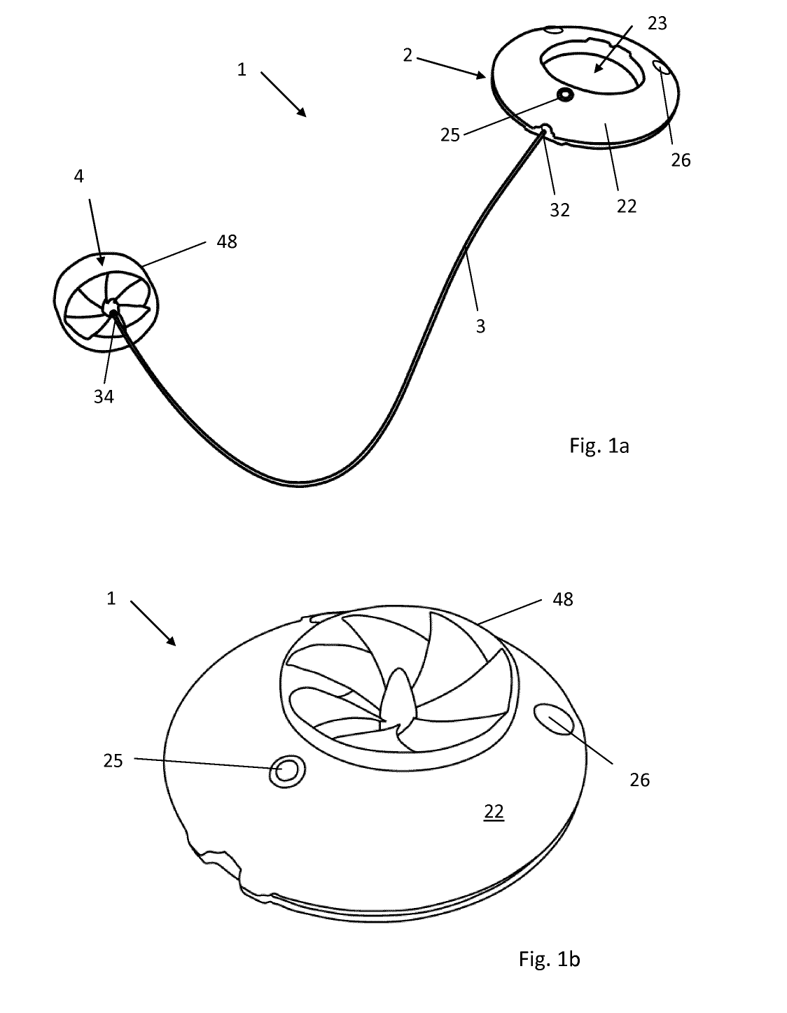

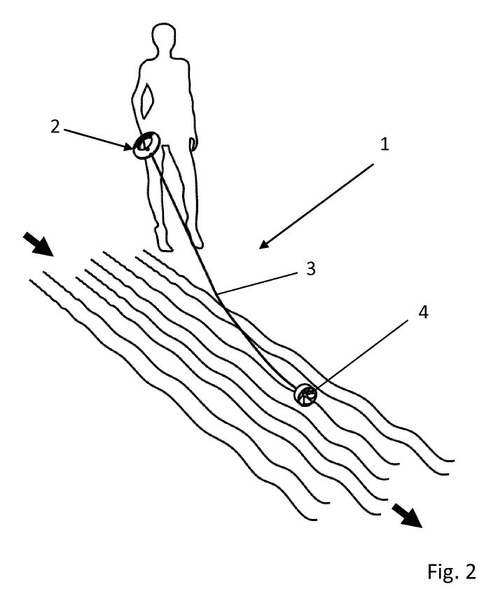

FIG. 1a shows an example of a hydroelectric apparatus 1. The hydroelectric apparatus 1 comprises a generator device 2, a flexible shaft 3 and a runner, rotor or turbine 4. The turbine 4 comprises a central shaft or core 44, a plurality of blades 46 and an annular frame or rim 48 surrounding the plurality of blades 46. In use, the entire turbine 4 is placed in a flowing fluid current, such as a river or water channel or the like (as shown in FIG. 2), or the turbine is actively pulled through a fluid, for example by a boat. The entire turbine 4 including the frame or rim 48 rotates when the water passes through the turbine 4.

The flexible shaft 3 is connected to the turbine 4 with a first plug or first shaft connector 34. The first plug or first shaft connector 34 transmits, when attached, any rotational movement of the turbine 4 to the flexible shaft 3 such that the flexible shaft 3 rotates at the same speed as the turbine 4. The first shaft connector 34 may allow a reversible connection of the flexible shaft 3 with the turbine 4 such that the flexible shaft can be attached to the turbine 4 prior to use and can be removed again after use.

The flexible shaft 3 can be a flexible cable and can be made from usual cable materials, such as steel wires or fiber materials, for example as used for speedometers. Other cables that can transmit a rotational movement can be used as well. The length of the cable can be adapted to the application.

On its other end, the flexible shaft or cable 3 comprises a second plug or second shaft connector 32 for connecting the flexible shaft 3 to a shaft of a generator. The second shaft connector 32 transmits, when connected to the shaft of the generator, the rotational movement of the flexible shaft 3 to the shaft of the generator thereby driving the generator. The second plug 32 may also provide a reversible connection such that the flexible shaft 3 can be detached or removed from the generator unit 2 and/or the turbine 4 after use. This enables an easier transport of the apparatus.

The first shaft connector 34 and the second shaft generator 32 may have a winding and may be screwed into the corresponding nut windings in the turbine and the generator, respectively. In this case the winding may have an orientation such that a rotation of the turbine fastens the connectors when the turbine is in use. Other connectors, such as bayonet connectors, quick-click connectors or any other connector for transmitting the rotational movement may be used as well. It is an advantage, if the connector can be easily, quickly and reliably attached.

In use, the flexible shaft and the turbine are rotating together and the turbine is solely supported by the flexible shaft. No other connection between the turbine and the generator is required.

The generator device 2 of the described example comprises a housing 22 in which the generator is arranged.

The housing 22 may, in addition to the generator, comprise further components, such as voltage and/or current regulators, converters, controls and others.

The housing 22 may, for example, comprise a control light 25, such as an LED that is turned on as soon as the voltage or power generated by the generator reaches a predetermined level. The control light may indicate that sufficient electrical power is provided at the electrical connector 26 to supply an external device connected to the generator device. The electrical connector can be a USB (Universal Serial Bus) connector or any other electric connection. In this way the electric energy generated by the apparatus can be used to drive or charge other devices, for examples torches, mobile phones or other electronic devices.

The housing 22 may also comprise a light source for emitting light. The generator device 2 may also comprise, as an optional feature, one or more secondary batteries for storing electric energy. The secondary batteries may be charged whenever the generator generates more electric energy than is consumed otherwise. The secondary batteries can be used to supply or charge other devices, even if no running water is available and the rotor is not turning or not connected. The secondary batteries may also compensate for events, when more electric energy is needed than is currently generated by the generator.

The generator device 2 may further contain electronics and integrated circuits to control, transform and/or adapt the generated voltage to the voltage needed at the output connectors or at the light source, to charge the secondary batteries, if applicable and/or to control additional features of the device. The generator device may optionally provide further external interfaces and connectors, for example plugs for charging the secondary batteries from other electric power sources such as a conventional electric power grid, solar panels or other sources.

In the example shown in FIGS. 1a and 1b, the housing 22 has a substantially disc-like or ellipsoidal shape with a circular opening 23. The circular opening 23 has a diameter that substantially corresponds to the diameter of the turbine 4 and is adapted to receive the turbine 4, when the hydroelectric apparatus 1 is not in use, as shown in FIG. 1b and as described below.

If not in use, the hydroelectric apparatus can be stored and transported as shown in FIG. 1b. The flexible shaft 3 may be removed from the turbine and from the generator and may be stored, for example inside the housing 22. The housing 22 can provide a reception portion 23 for receiving the flexible shaft 3 when the turbine is not in use. The turbine 4 may be placed in the circular opening 23 of the generator device 2 as shown in FIG. 1b and the entire apparatus is ready for transport or storage enabling a compact transport. This is advantageous for mobile use of the apparatus as it can be easier transported and no parts get lost. However, a housing without a reception portion can be used as well allowing for smaller dimensions of the housing. In the example of FIGS. 1a and b, the circular opening 23 is not centered in the housing 22 but displaced from the center. This makes the design of the housing more compact.

The substantially disc-like or ellipsoidal shape provides a compact and handy design that can be easily transported and handled. However, different types of housings may be used.

FIG. 2 shows the apparatus of FIGS. 1a and b in use. The turbine can be removed from the circular opening 23 of the housing 22 prior to use of the hydroelectric apparatus. The turbine 4 is then connected to the flexible shaft 3 via the first connector 34 and the other end of the flexible shaft 3 is connected to the shaft of the generator 20 at the housing 22 of the generator device 2 with the second connector 32, as shown in FIG. 1a. The turbine 4 is now rotatably connected to the generator device 2 and can be placed in the water while the generator device remains outside the water, as illustrated in FIG. 2. The turbine 4 is attached to the generator device 2 only via the flexible shaft 3. There is no other support or connection of the turbine 4 except the flexible shaft 3 and the turbine 4 can rotate freely in the river. As soon as the turbine is placed in sufficiently strong water current, the turbine starts to rotate, driven by the water flowing through the turbine. The rotation is transmitted to the generator via the flexible shaft 3 and the generator can start producing electric energy. It is noted that the turbine 4 can move freely in the water and that the flexible shaft 3 leave a considerable flexibility for the turbine 4. The turbine can be designed to arrange and position itself in the water current in an optimized way as explained below.

The generator device 2 is placed outside the water and can be hold by a user as shown in FIG. 2. The generator device 2 can be attached to any available fixation at the river bank. For example a rod can be used. Anchors or other means can be provided as well. The circular opening 23 in the housing can be used for fixation of the generator device 2. A rope can also be attached to the housing, if considered necessary. There are many possibilities available of how to support the housing which may be adapted to the specific requirements and the situation at the point of use. It is to be understood that the shown example is just one of many different ways of possible fixations of the generator device 2.

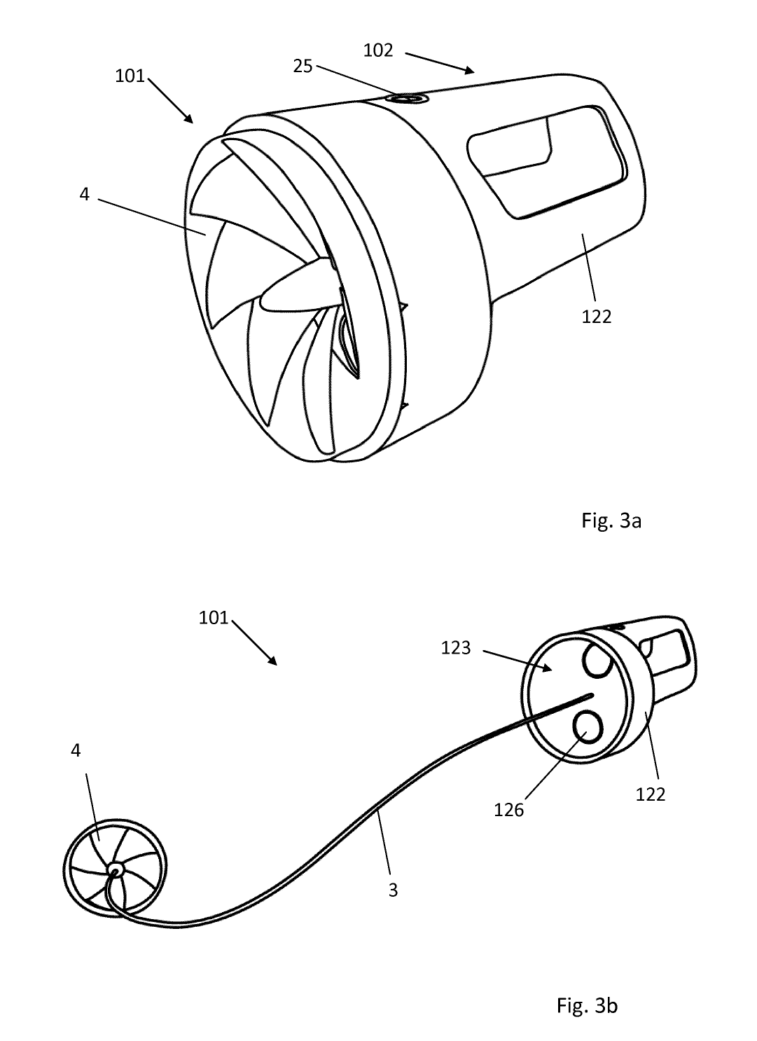

FIGS. 3a and 3b show a second example of a hydroelectric apparatus 101 that is similar to the hydroelectric apparatus 1 of the previous figures. The turbine 4 and the flexible shaft 3 may be as described with respect to FIGS. 1 and 2. The generator device 102 may be similar to the generator device 2 of the previous figures and may contain the same or similar elements. However, the generator unit 102 shown in FIG. 3 has a different housing 122. The housing 122 comprises a handle 125 and a central opening 123 at one side. The central opening 123 has a diameter that substantially corresponds to the diameter of the turbine and is adapted to receive the turbine 4, when the generator is not in use, as shown in FIG. 3a. Other shapes of the generator device may be used. The electrical connection 126 may be arranged at the bottom of the central opening 123.

Other types of housings may be used. For example, the housing can have a substantially cylindrical shape. The size and/or dimension of the housing may depend on the output power of the apparatus. If higher power is intended, the housing dimension may be increased and other types and shapes of housing may advantageous. If the generator and/or the electronics get larger and heavier in weight, stationary or vehicle bound solutions may be advantageous. In another application, the generator may be installed in a boat, with or without separate housing. The housing may also have the shape of a buoy or a buoyancy chamber, pontoon or a floater on or in which the generator unit is arranged. The buoyancy chamber or floater can be anchored at the bottom of a river or can be attached to a river bank. An electric cable may be used to transfer the generated electric energy from the buoyancy chamber or floater to a point of use.

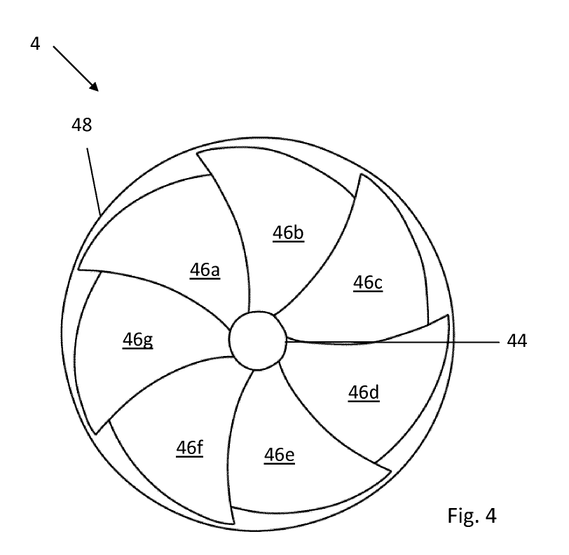

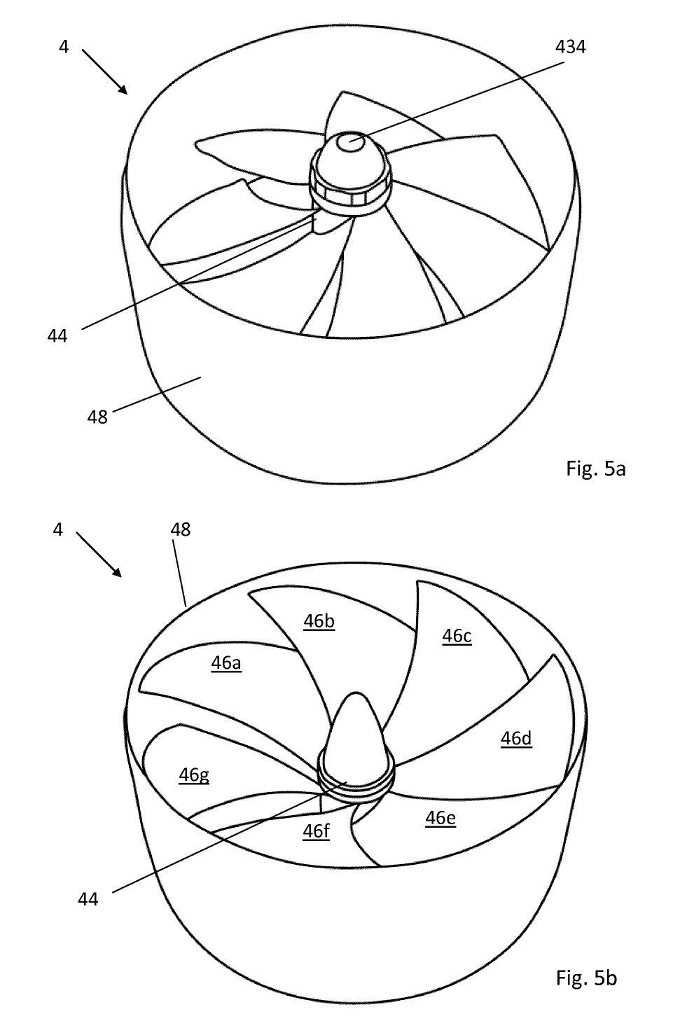

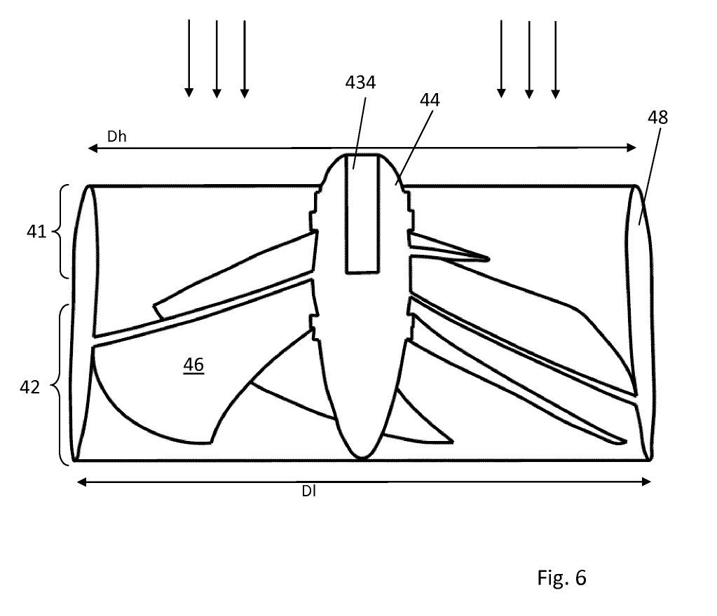

FIGS. 4, 5a and 5b show an example of the turbine 4 in more detail in different views. The turbine 4 comprises a central shaft or core 44 and a plurality of blades 46 arranged between the central shaft 44 and the rim or frame 48. In the example shown, seven blades 46a to 46g are arranged equally distributed around the central shaft 44. While any other number of blades can be used, it has been found that seven or eight blades are advantageous in this configuration and provide an efficient turbine. Using fewer blades reduces the efficiency considerably. However, a smaller number of blades may be used for reducing manufacturing costs, if lower efficiency is acceptable.

Each blade 46a to 46g of the plurality of blades 46 may be identical, as in the example shown, and the blades 46a to 46g are equally distributed around the core 44, as can be seen from FIG. 4.

The blades 46a to 46g may be arranged such that always two of the plurality of blades 46 overlap, if seen in the flow direction as shown in the example of FIG. 4. This overlap increases the efficiency of the turbine but can be omitted if lower is efficiency is acceptable.

FIGS. 5a and 5b show the turbine 4 with more details in a perspective view. FIG. 5a shows the high pressure side, where the water current enters the turbine, when in use. The flexible shaft 3 can be attached to connector portion 434 at this high pressure side. FIG. 5b shows the low pressure side where the water exits the turbine.

The annular rim or frame 48 has an annular or tube-like shape surrounding the plurality of blades 46. The radially outer edge of each one 46a to 46g of the plurality of blades 46 is attached to the inner wall of the frame 48 such that the frame 48 rotates together with the plurality of blades 46, when the turbine 4 is in use. The frame 48 provides mechanical stability to the blades 46 and protects the blades 46. This makes the turbine 4 more reliable in particular when the turbine is used in a mobile power station. If the water is not deep enough or stones or other barriers are present, a usual propeller may get stack and no electricity is produced. The frame 48 of the present disclosure acts as a turbine protection and rotation is still possible, even when the frame hits the ground or another item in the water. In addition, the tube-like structure of the frame 48 guides the water through the blades 46 which increases efficiency of the turbine 4.

The frame of the turbine or runner 4 forms a tube with a channel for the water flow between the central shaft or core 44 and the frame 48. The blades 46 are arranged inside the channel of the tube such that the water current through the channel rotates the entire turbine 4 including the frame 48. The channel may have a cylindrical form, where the wall of the frame 48 forms a shell or tube acting as a fin or stabilizer. This provides the advantage that the water current centers the turbine 4 in the flowing water and orients the turbine 4 in an optimized position to the water current direction. The turbine is thus self-centering and stabilizing. This increases the efficiency of the turbine 4. The runner or turbine 4 is only supported by the flexible shaft 3 and can thus rotate freely but also can turn and change its orientation with respect to the water flow. The channel formed by the frame 48 ensures that the turbine, and in particular the axis of rotation is adjusted along the flow direction thereby increasing efficiency of the hydroelectric apparatus. Conventional power plants, in contrast, have an axis of rotation that is fixedly arranged with respect to the water flow, where the water current has to be directed towards the blades of the turbine. In contrast, the turbine 48 of the present application orients and positions itself in the water current. While a simple cylindrical shape with straight walls has certain advantages, the turbine 4 may have additional features to further improve efficiency of turbines as will be explained below.

The channel of the turbine or runner 4 may comprise a guiding or alignment section or portion 41 and a blades section or portion 42. The guiding section 41 may be arranged in front of the blades section 42 with respect to the flow direction. A substantially parallel and laminar water flow can be achieved in the guiding section 41 before the water flow enters the blades 46. This guiding section 41 further improves the orientation and alignment of the turbine with respect to the flow direction of the water current.

The cylindrical wall of the frame and the guiding section are examples of alignment means and other examples of alignment means, such as fins, may be used in addition or alternatively.

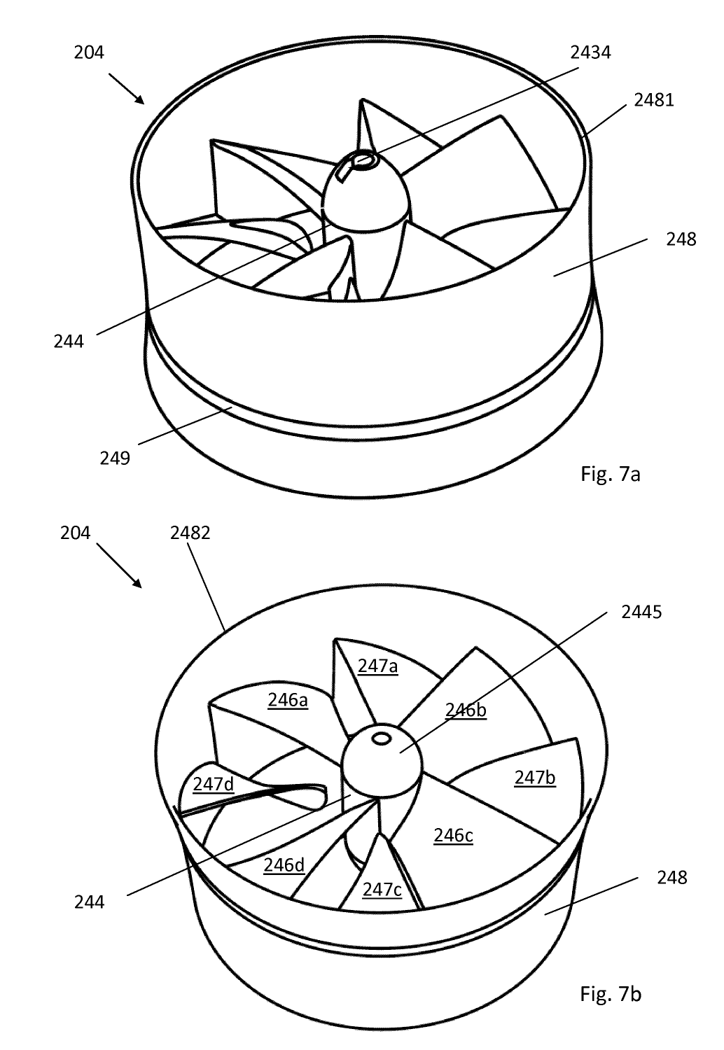

FIG. 6 shows a cross section of a turbine or runner 4 of the turbine of FIGS. 5a and 5b. The arrows indicate the direction of the water current, when the turbine is in use. This direction is termed flow direction herein. The entrance side or high pressure side of the turbine 4, where in use the water flow enters the turbine 4, is shown at the top side in FIG. 6 while the water exit side or low pressure side of the turbine 4 is shown at the bottom side. The central shaft or core 44 comprises the connector portion 434 for attaching the flexible shaft 3. In one example the connector portion 434 can be implemented as a blind hole with an internal screw thread. A corresponding external thread at the end of the flexible shaft 3 can be screwed into the connector portion 434. Alternative implementations of the connector portions, such as bayonet connectors, twist-lock connectors or quick-click connectors or others are also possible.

As apparent from FIG. 6, the channel width or cross section may vary along the flow direction to increase efficiency of the turbine 4. The channel of the turbine 4 may comprise the guiding or accelerator section or portion 41 and the blades section or portion 42. The width of the channel is reduced along the flow direction in the guiding section 41 by reducing the available volume for the water when passing through the channel, thereby accelerating the water speed. The guiding section 41 may therefore be termed accelerating section. The plurality of blades 46 is arranged in the blade section 42 where the channel cross section is at least constant or even enlarged towards the channel exit along the flow direction.

The central shaft or core 44 may have a cylindrical shape in a simple example. The central shaft or core 44 may have a varying diameter along the flow direction to increase efficiency of the turbine. The variation of the diameter of the central shaft 44 along the flow direction varies the channel cross section additionally. The maximum diameter of the channel width may be is in the upper half of the core 44. It is advantageous to have the maximum diameter in the upper third of the core 44. The maximum diameter may be substantially at a position, where the front end of the blades 46 is attached to the core 44, for examples where the acceleration section 41 ends and the blade section 42 starts.

In addition or alternatively to the variation of the thickness of the core 44, the rim or frame 48 may have a profile with varying thickness. In particular the internal surface of the rim 48 may be curved along the flow direction thereby altering the channel width as described above. The outer surface of the rim 48 may have a substantially cylindrical shape. In one example the rim 48 may have a substantially conical shape as shown in FIG. 6. A diameter Dh of the rim 48 at the entrance of the channel at the high pressure side may be smaller than the diameter Dl of the rim 48 at the channel exit at the low pressure side. The substantially conical shape is useful for inserting and receiving the turbine in the reception portion 23, 123 of the generator unit 2, 103. This makes handling of the mobile hydroelectric apparatus 2, 102 easier. The substantially conical shape of the outer surface also helps to align or orient the turbine with the flow direction of the water current, when the hydroelectric apparatus is in use. This reduces vibrations and increases the efficiency of the hydroelectric apparatus.

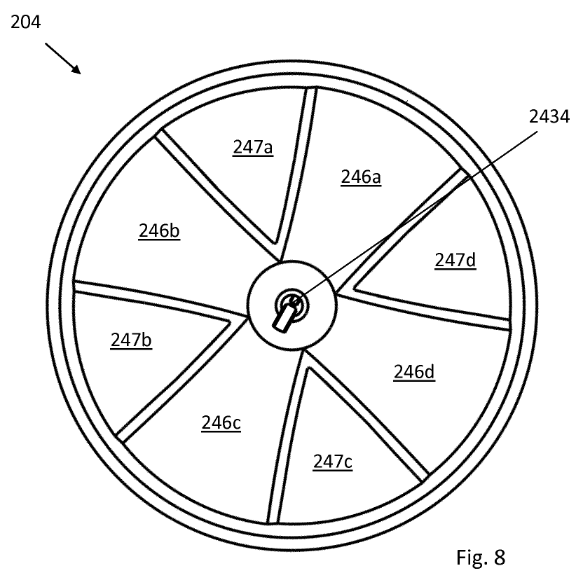

FIGS. 7 to 10 show a second example of a turbine 204. The turbine 204 corresponds to the turbine 4 shown and described in more detail with respect to FIGS. 4 to 6 and may be equally used with the apparatus' shown and described with respect to FIGS. 1 to 3. Features and/or designs used with the turbine 4 described above may be used with turbine 204 unless explicitly described or shown otherwise. It is also apparent that features shown and described with one example of the turbine can be combined or replaced with features shown with other examples.

The turbine 204 comprises a central shaft 244, a rim or frame 248 of a substantially cylindrical shape with a plurality of blades 246, 247 attached to the inner wall of the rim 248.

FIG. 7a shows the annular entrance 2481 at the high pressures side or entrance side of the turbine 204, where in use the water flow enters the channel formed inside the rim 248. A connector portion 2434 is arranged at the high pressure side end of the central shaft 244. The flexible shaft 3 may be attached to the connector portion 2434 as the only link to the generator unit. In this example the connector portion 2434 may be implemented as a bayonet socket and the flexible shaft 3 may comprise a corresponding bayonet joint.

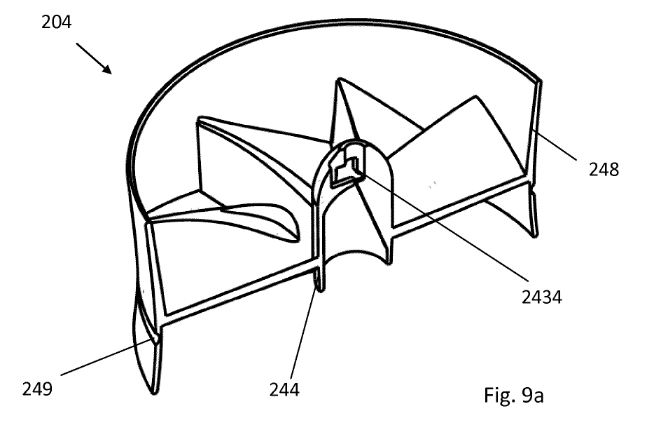

The turbine 204 shown in this example comprises two different types of blades, a primary blade 246a, 246b, 246c, 246d and a secondary blade 247a, 247b, 247c, 247d, which are alternatingly arranged in the channel formed by the rim 248 and the central shaft 244. The primary blades 246a, 246b, 246c, 246d are attached to the central shaft 244 and the rim 248 and support the rim 248. The secondary blades 247a, 247b, 247c, 247d are only attached to the rim 248 and do not extend to the central shaft 244 leaving a gap between the central shaft 244 and each of the secondary blades 247a, 247b, 247c, 247d. The secondary blades 247a, 247b, 247c, 247d have a smaller surfaces than the primary blades s246a, 246b, 246c, 246d and have no contact to the central shaft 244, as can be seen from the top view of FIG. 8. The inventors found that this design avoids overlaps between the adjacent blades and simplifies manufacturing while largely maintaining the efficiency of the rotor shown and described above. In the example shown four primary blades 246a, 246b, 246c, 246d and four secondary blades 247a, 247b, 247c, 247d are used, which has been found as a good compromise between high efficiency and manufacturing costs. However, more or less blades may be used. It is advantageous to use the same number of primary blades 246 as of secondary blades 247 arranged alternatingly around the central shaft 244.

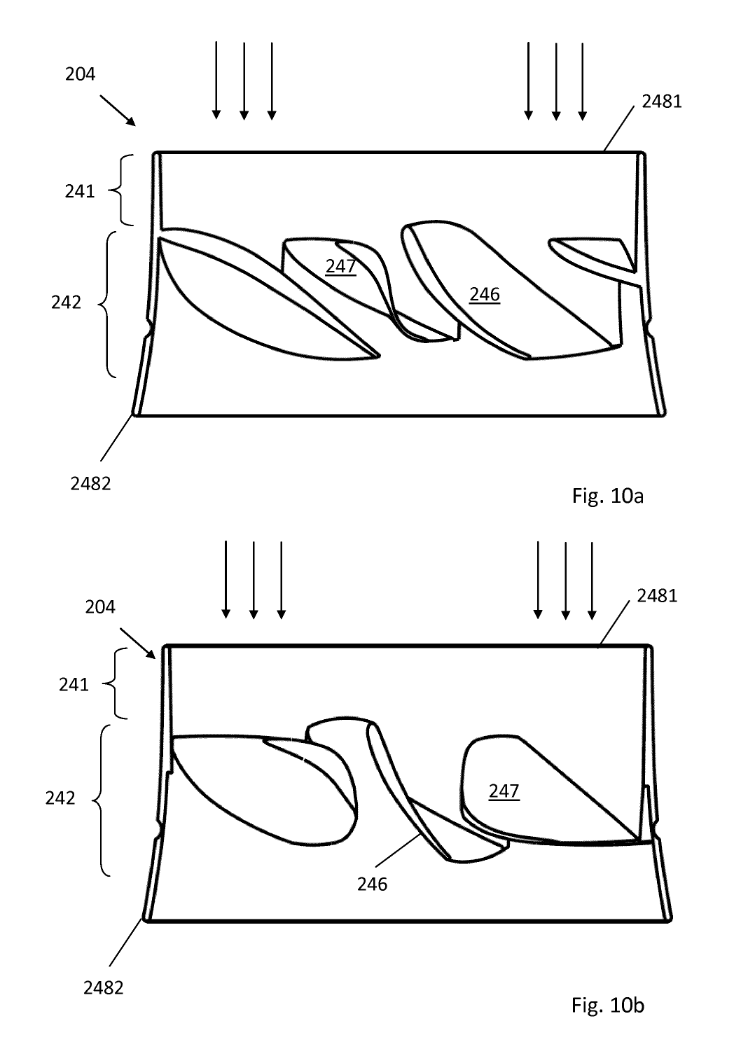

Each of the primary blades 246 and the secondary blades may be curved and may have a wing profile. The angle of the blades with respect to the undisturbed water may vary. Usually the angle is smaller at the entry or high pressure side and continuously increases toward the exit or low pressure side. The curvature may be stronger closer to the shaft 244 than at the rim 248. This can also be seen from the cross sections in FIGS. 10a and 10 b.

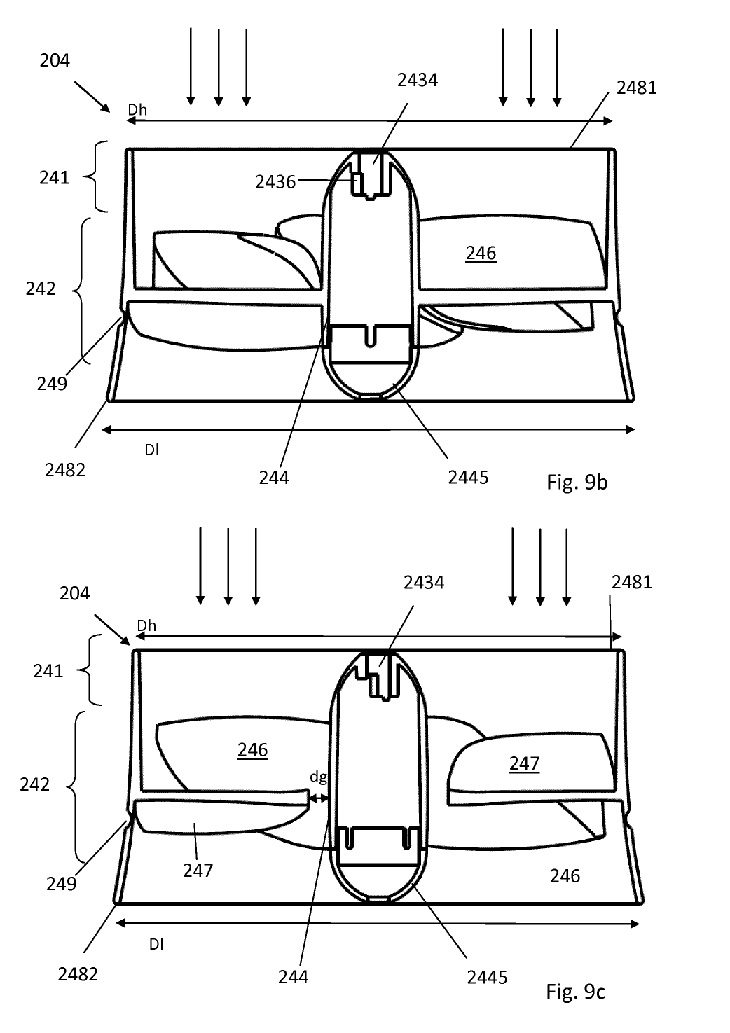

FIGS. 9a, 9b and 9C show cross-sectional views through the center of the rotor 204 of FIGS. 7a and 7b and 8. The central shaft 244 has a substantially cylindrical shaft 244 with a rounded tip facing the high pressure side. A central opening at the rounded the tip provides the connector portion 2434 in which a bayonet socket of a bayonet joint is integrated. The central opening comprises a circular opening and a slit into which the corresponding bayonet ending with at least one pin of the flexible shaft 3 can be inserted. The connector portion 2434 further comprises a stop up to which the end of the flexible shaft can be inserted into the central opening of the connector portion. The stop further comprises a spring with a predetermined resistance such that the flexible shaft can be pushed a little further into the connector portion. In this position the pin of the bayonet connection on the flexible shaft can be twisted into a clip 2436 arranged inside the connector portion to secure the flexible shaft 3 in the rotor 204 and to provide a secure fixation of the rotor and simultaneous rotation of the turbine and the flexible shaft 3. A similar connection can be used at the generator device.

A cap 2445 not shown in FIG. 9a but in FIGS. 7b, 9b and 9c may be attached to the central shaft 244 at the low pressure side and may close and open end of the central shaft, for example as shown in FIG. 7b.

FIGS. 9b and 9c show a cross-section through the center of rotation of the turbine 204 in different cuts. FIG. 9b shows a cut through two of the primary blades 246. The primary blades 246 are attached to the central shaft 244 and the rim 248 and provide a mechanical support and connection of the rim 248 with the central shaft 244.

FIG. 9b shows a cut through two of the secondary blades 247. The secondary blades 247 are attached to the rim 248 but are not connected to the central shaft 244. A gap with distance dg remains between the central shaft 244 and the inner tip of the secondary blade 247.

The rim 248 forms a channel for the water flow and comprises a guiding section 241 and a blade section 242 similar to the guiding section of the turbine 4 described with respect to FIGS. 4 to 6. The channels and in particular the guiding section 241 of the channel orients and aligns the turbine 204 in the water current. The turbine 204 is thus self-centering and stabilizing when rotating in flowing liquid.

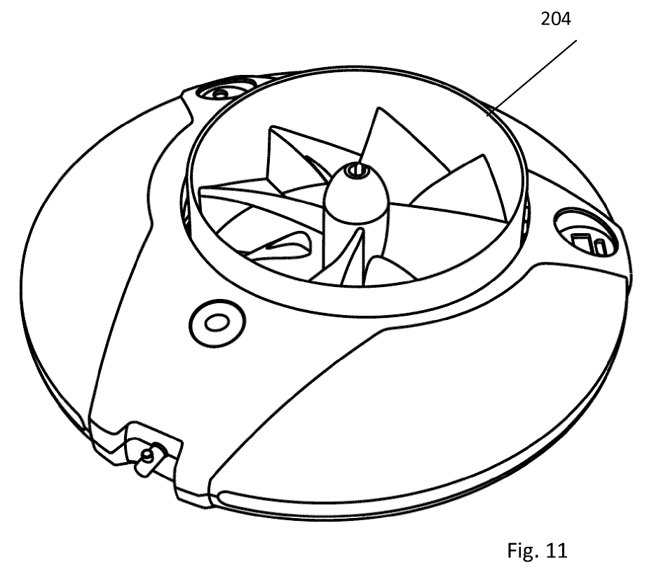

The channel formed inside the rim 248 has a conical form and has an inner diameter Dh in the entrance area 2481 at the high pressure side that is smaller compared to an inner diameter Dl the exit area at the low pressure side 2482. The wall of the rim 248, however, may have a substantially uniform thickness along the flow direction except for a groove or notch 249 formed circumferentially in the outer wall of the rim 248. The groove or notch 249 may be formed in the blade section 242. The groove or notch 249 can be used to hold and fix the turbine 204 in the reception portion 223 of the housing 222 as shown in FIG. 11.

FIGS. 10a and 10b show a cross section through the turbine 204 in different cuts. These sections are not taken through the diameter of the turbine 204 but rather show the profile of the primary blades 246 and of the secondary blades in different views.

The hydroelectric apparatus has been described with respect to a mobile device that can be used in a river, a water channel or in another working fluid in a mobile way. No additional installations are required if the generator unit is fixed at the river bank or another stationary place outside the fluid. However, other applications are possible. The hydroelectric apparatus can be scaled to any dimension. The generator unit can be larger in size and weight and can be made mountable to a car or truck or can be made stationary. The hydroelectric apparatus can be equally used on a boat or a pontoon to generate electric energy while the boat or pontoon is fixed of parked in flowing water stream. The turbine may also be pulled behind, thereby generating energy for example on a sailing boat. The generator unit may be fixedly installed on the boat in such an application or the apparatus described above may be used.

The hydroelectric apparatus has been described with respect to specific embodiments above that have been found to increase the efficiency of the turbine and thus allow a compact size of the turbine in relation to the energy harvested from the water current. The specific embodiment show several features that are not necessary to implement the invention as defined by the claims. A person skilled in the art may modify the apparatus and adapt it to specific requirements. For example, different types of housings may be used. Also different features can be added to the generator device. Further the geometry of the turbine may be varied and a person skilled in the art may further optimize the geometry or material of the runner for higher efficiency.

The hydroelectric apparatus has been optimised for efficiency in order to generate the maximum electric energy from a given water flow and to keep the dimensions and weight of the apparatus as small as possible. This is in particular advantageous when the turbine is not fixedly mounted. The more efficient the hydroelectric apparatus is, the smaller the turbine can be made which in turn makes the hydroelectric apparatus lighter and thus easier to transport as a mobile device. A person skilled in the art, however, may also design the turbine simpler to reduce manufacturing costs, for example for applications where energy efficiency is less important.

As mentioned above, a person skilled in the art may modify or adapt the apparatus as described for the use with other fluids or liquids. A modified apparatus may even be used with a gas or with more viscous liquids or even a gel.

The apparatus has been described with respect to a hydroelectric apparatus for generating electric energy from a fluid current. The electric energy may be used for different applications, such as for example light, heat or any type of mechanical energy and/or electronics. The rotational energy of the turbine and the shaft may also be used directly via a mechanical transmission to drive mechanical systems, for example a pump a vent of any other application.

1. An apparatus (1) for producing electric energy from a working fluid, the apparatus comprising:
a generator unit (2);
a flexible shaft (3) that is, at a first end, rotatably attached to the generator unit (2), and, a second end, to a turbine (4; 204), wherein the turbine (4; 204) comprises a plurality of blades (46; 246; 247) and a rim (48; 248) attached to at least two of the plurality of blades.

2. The apparatus of claim 1, wherein the rim (48; 248) has a substantially cylindrical shape.

3. The apparatus of claim 1, wherein at least an outer surface of the rim (48; 248) has a shape of a truncated cone.

4. The apparatus of claim 1, wherein the turbine (4; 204) comprises a channel formed within the rim (48; 248), the channel comprising a guiding portion (41; 241) and a blade portion (42; 242), wherein the guiding portion is arranged in front of the blade section with respect to a flow direction and wherein the plurality of blades (46; 246, 247) is arranged in the blade portion (42; 242).

5. The apparatus of claim 1, wherein the turbine (4; 204) comprises a channel formed within the rim (48; 248), and wherein a cross section of the channel varies along a flow direction.

6. The apparatus of claim 5, wherein the cross section of a channel entrance (Dh) at a high pressure side is smaller than a cross section at a channel exit (Dl) at a low pressure side.

7. The apparatus of claim 5, wherein the cross section of the channel has a minimum in a channel section between a channel entrance and a channel exit.

8. The apparatus of claim 1, wherein the rim (48; 248) has a profile wherein the profile's thickness varies along a flow direction.

9. The apparatus of claim 1, wherein the generator unit (2) comprises a reception portion (23, 123) that receives the turbine.

10. The apparatus of claim 1, wherein the turbine (4) comprises at least seven blades (46; 246, 247).

11. The apparatus of claim 1, wherein the flexible shaft (3) comprises a connector at at least one of the first end and or at the second end for reversibly connecting the flexible shaft to at least one of the generator unit and the turbine.

12. A turbine (4; 204) for an hydroelectric apparatus, the turbine comprising a central shaft, a plurality of blades (46; 246, 247), and a rim (48; 248) attached to at least two of the plurality of blades, wherein the rim (48; 248) has a thickness that varies along a flow direction.

13. The turbine of claim 12, wherein the turbine (4; 204) comprises a channel formed within the rim (48; 248), the channel comprising a guiding portion (41; 241) and a blade portion (42), wherein the guiding portion is arranged in front of the blade portion with respect to a flow direction and wherein the plurality of blades (46; 246, 247) is arranged in the blade section (42; 242).

14. The turbine of claim 12, further comprising a channel formed within the rim (48; 248), and wherein a cross section of the channel varies along a flow direction.

15. The turbine of claim 14, wherein the cross section of a channel entrance (Dh) is smaller than the cross section at a channel exit (Dl).

16. The apparatus of claim 14, wherein the cross section of the channel has a minimum in a channel section between a channel entrance and a channel exit.
